(19) United States
(12) Patent Application Publication
(10) Pub. No.: US 2015/0280248 A1
(43) Pub. Date: Oct. 1, 2015

(54) GRAPHENE QUANTUM DOT-CARBON MATERIAL COMPOSITES AND THEIR USE AS ELECTROCATALYSTS

(71) Applicants: James M. Tour, Bellaire, TX (US); Huilong Fei, Houston, TX (US); Ruquan Ye, Houston, TX (US)

(72) Inventors: James M. Tour, Bellaire, TX (US); Huilong Fei, Houston, TX (US); Ruquan Ye, Houston, TX (US)

(73) Assignee: William Marsh Rice University, Houston, TX (US)

(21) Appl. No.: 14/669,849

(22) Filed: Mar. 26, 2015

Related U.S. Application Data
(60) Provisional application No. 61/970,686, filed on Mar. 26, 2014.

(51) Int. Cl. H01M 4/90; H01M 4/86

(52) U.S. Cl. CPC H01M 4/9083; H01M 4/8657

(57) ABSTRACT

In some embodiments, the present disclosure pertains to methods of making a composite by associating graphene quantum dots with a carbon material, where the associating results in assembly of the graphene quantum dots on a surface of the carbon material. The methods of the present disclosure may also include a step of doping at least one of the graphene quantum dots and the carbon material with one or more dopants. Additional embodiments of the present disclosure pertain to composites that are formed by the methods of the present disclosure. In some embodiments, the composites are capable of mediating oxygen reduction reactions, oxygen evolution reactions, and combinations thereof. As such, the composites of the present disclosure can be utilized as an electrocatalyst for oxygen reduction reactions, oxygen evolution reactions, and combinations thereof. The composites of the present disclosure can also be utilized as a component of an energy storage device.

### CROSS-REFERENCE TO RELATED APPLICATIONS

This application claims priority to U.S. Provisional Patent Application No. 61/970,686, filed on Mar. 26, 2014. The entirety of the aforementioned application is incorporated herein by reference.

### STATEMENT REGARDING FEDERALLY SPONSORED RESEARCH

This invention was made with government support under Grant No. W911NF-11-1-0362, awarded by the U.S. Department of Defense; Grant No. FA9550-12-1-0035, awarded by the U.S. Department of Defense; Grant No. FA9550-09-1-0581, awarded by the U.S. Department of Defense; and Grant No. N00014-09-1-1066, awarded by the U.S. Department of Defense. The government has certain rights in the invention.

### BACKGROUND

Current electrocatalysts have numerous limitations, including scarcity and high costs of starting materials, limited manufacturing scalability, limited electrochemical performance, and limited electrocatalytic activity. As such, a need exists for the development of more effective electro catalysts.

### SUMMARY

In some embodiments, the present disclosure pertains to methods of making a composite. In some embodiments, the methods include a step of associating graphene quantum dots with a carbon material, where the associating results in assembly of the graphene quantum dots on a surface of the carbon material. In some embodiments, the graphene quantum dots are self-assembled on the surface of the carbon material. In some embodiments, the graphene quantum dots are dispersed on the surface of the carbon material. In some embodiments, the graphene quantum dots form an interconnected network on the surface of the carbon material.

In some embodiments, the carbon material includes, without limitation, graphite, graphite oxide, graphene, graphene oxide, graphene nanoribbons, graphene oxide nanoribbons, carbon nanofibers, carbon nanotubes, split carbon nanotubes, activated carbon, carbon black, functionalized carbon materials, pristine carbon materials, doped carbon materials, reduced carbon materials, stacks thereof, and combinations thereof.

In some embodiments, the methods of the present disclosure also include a step of doping at least one of the graphene quantum dots and the carbon material with one or more dopants. In some embodiments, the doping occurs during or after associating the graphene quantum dots with the carbon material. In some embodiments, the doping results in the formation of a doped composite material. In some embodiments, the dopant includes boron and nitrogen.

Additional embodiments of the present disclosure pertain to composites that are formed by the methods of the present disclosure. In some embodiments, the composites of the present disclosure include graphene quantum dots and a carbon material, where the graphene quantum dots are assembled on a surface of the carbon material. In some embodiments, the composites of the present disclosure may also be doped with one or more dopants, such as boron and nitrogen.

In some embodiments, the composites of the present disclosure are in the form of flat sheets. In some embodiments, the composites of the present disclosure have a thickness ranging from about 5 nm to about 1 μm. In some embodiments, the composites of the present disclosure have a thickness ranging from about 5 nm to about 10 nm.

In some embodiments, the composites of the present disclosure are capable of mediating oxygen reduction reactions, oxygen evolution reactions, hydrogen oxidation reactions, hydrogen evolution reactions, and combinations thereof. In some embodiments, the composites of the present disclosure have a current density that ranges from about 1 mA/cm² to about 15 mA/cm². In some embodiments, the composites of the present disclosure have a current density that ranges from about 2 mA/cm² to about 4 mA/cm².

In some embodiments, the composites of the present disclosure are utilized as an electrocatalyst for oxygen reduction reactions, oxygen evolution reactions, hydrogen oxidation reactions, hydrogen evolution reactions, and combinations thereof. In some embodiments, the composites of the present disclosure are utilized as a component of an energy storage device, such as a lithium ion battery or a supercapacitor.

### DESCRIPTION OF THE FIGURES

FIG. 1 provides a scheme of a method of making composites.

FIG. 2 illustrates a preparation procedure for making boron nitride-doped graphene quantum dot/graphene (BN-GQD/G) nanocomposites (also referred to as nanoplatelets).

FIG. 3 provides a high resolution transmission electron microscopy (HRTEM) image of representative GQDs synthesized from anthracite coal. The inset is the fast fourier transform (FFT) image that shows the crystalline hexagonal structure of the GQD.

FIG. 4 provides an optical image of a mixture of graphene quantum dots (GQDs) and graphene oxide (GO) at a GQD:GO mass ratio of 2:1 in water before (FIG. 4A) and after (FIG. 4B) a hydrothermal reaction. The stable aqueous suspension of the mixture precipitated after the hydrothermal reaction.

FIG. 5 provides scanning electron microscopy (SEM) images of GQD/G hybrid nanoplatelets obtained by the hydrothermal reaction illustrated in FIG. 4.

FIG. 6 provides an SEM image of graphene prepared by annealing GO aerogel at 1000° C. for 30 minutes, showing the relatively smooth surface compared to that of GQD/GO.

FIG. 7 provides a transmission electron microscope (TEM) image of GQD/G hybrid nanoplatelets obtained by hydrothermal self-assembly. The image was taken on a lacy carbon grid.

FIG. 8 provides SEM images of nanocompo sites obtained when GQD and GO were hydrothermally mixed at a GQD:GO mass ratio of 1:1. Low magnification (FIG. 8A) and high magnification (FIG. 8B) images are shown.

FIG. 9 provides an SEM image of nanocomposites obtained when GQD and GO were hydrothermally mixed at a GQD:GO mass ratio of 3:1.

FIG. 10 provides images of various BN-GQD/G nanoplatelets. FIG. 10A provides an SEM image of flake-like BN-GQD/G-30 nanoplatelets. FIG. 10B provides a TEM image of a typical individual BN-GQD/G-30 nanoplatelet. FIG. 10C provides a higher magnification TEM image of a BN-GQD/G-30 nanoplatelet. FIG. 10D provides an atomic force microscopy (AFM) image of a partially stacked BN-GQD/G-30 nanoplatelet with the step heights shown in the bottom graph.

FIG. 11 provides an X-ray photoelectron spectroscopy (XPS) survey spectra for dopant-free GQD/G (DF-GQD/G-30), nitrogen-doped GQD/G (N-GQD/G-30), boron and nitrogen-doped GQD/G (BN-GQD/G-60 and BN-GQD/G-30), and boron/nitrogen doped graphene (BN-G-30).

FIG. 12 provides high resolution XPS N 1s (FIG. 12A) and XPS B 1s (FIG. 12B) of BN-GQD/G-10, BN-GQD/G-30 and BN-GQD/G-60. All the binding energies are referenced to C is at 284.5 eV.

FIG. 13 provides various data relating to the properties of BN-GQD/G nanocomposites. FIG. 13A provides cyclic voltammograms of the oxygen reduction reaction (ORR) on BN-GQD/G-30 in Ar- and O₂-saturated 0.1 M KOH solution at a scan rate of 100 mV s⁻¹. FIG. 13B provides RDE linear sweep voltammograms of ORR on a BN-GQD/G-30 electrode at different rotating speeds in an O₂-saturated 0.1 M KOH solution with a scan rate of 5 mV s⁻¹. FIG. 13C provides Koutecky-Levich plots of BN-GQD/G-30 derived from RDE voltammograms in FIG. 13B at different potentials. FIG. 13D provides rotating ring disk electrode (RRDE) voltammograms of ORR on a BN-GQD/G-30 electrode with a scan rate of 5 mV s⁻¹.

FIG. 14 provides cyclic voltammetry (CV) voltammograms of DF-GQD/G-30 (FIG. 14A), N-GQD/G-30 (FIG. 14B), BN-GQD/G-10 (FIG. 14C), BN-GQD/G-60 (FIG. 14D), BN-G-30 (FIG. 14E), and carbon supported platinum catalysts (Pt/C) (FIG. 14F) in O₂-saturated 0.1 M KOH solution at a scan rate of 100 mV s⁻¹.

FIG. 15 provides percentage of peroxide and the electron transfer number (n) of BN-GQD/G-30 at different potentials derived from the RRDE data in FIG. 13D.

FIG. 16 provides chronoamperometric response of BN-GQD/G-30 and Pt/C electrodes at −0.3 V in O₂-saturated 0.1 M KOH at a rotation speed of 900 rpm.

FIG. 17 provides rotating disk electrode (RDE) linear sweep voltammograms of ORR on DF-GQD/G-30 (FIG. 17A), N-GQD/G-30 (FIG. 17B), BN-GQD/G-10 (FIG. 17C), BN-GQD/G-60 (FIG. 17D), BN-G-30 (FIG. 17E) and Pt/C (FIG. 17F) at different rotating speeds in an O₂-saturated 0.1 M KOH solution with a scan rate of 5 mV s⁻¹.

FIG. 18 provides RDE linear sweep voltammograms of ORR for various samples at a rotating speed of 900 rpm and scan rate of 5 mV s⁻¹ (FIG. 18A), and the electrocatalytic activity given as the kinetic current density at −0.5 V for the samples (FIG. 18B). The samples included DF-GQD/G-30, N-GQD/G-30, BN-GQD/G-10, BN-GQD/G-30, BN-GQD/G-60, BN-G-30, and Pt/C.

FIG. 19 provides Nyquist (FIG. 19A) and Bode spectra (FIG. 19B) of BN-GQD/G-30 and BN-GQD/G-60 obtained with an AC amplitude of 10.0 mV in the frequency range from 100 kHz to 10 mHz.

### DETAILED DESCRIPTION

It is to be understood that both the foregoing general description and the following detailed description are illustrative and explanatory, and are not restrictive of the subject matter, as claimed. In this application, the use of the singular includes the plural, the word “a” or “an” means “at least one”, and the use of “or” means “and/or”, unless specifically stated otherwise. Furthermore, the use of the term “including”, as well as other forms, such as “includes” and “included”, is not limiting. Also, terms such as “element” or “component” encompass both elements or components comprising one unit and elements or components that include more than one unit unless specifically stated otherwise.

The section headings used herein are for organizational purposes and are not to be construed as limiting the subject matter described. All documents, or portions of documents, cited in this application, including, but not limited to, patents, patent applications, articles, books, and treatises, are hereby expressly incorporated herein by reference in their entirety for any purpose. In the event that one or more of the incorporated literature and similar materials defines a term in a manner that contradicts the definition of that term in this application, this application controls.

Current electrocatalysts have numerous limitations, including scarcity and high costs of starting materials, limited manufacturing scalability, limited electrochemical performance, and limited electrocatalytic activity. For instance, the scarcity and high cost of platinum-based electrocatalysts (such as carbon supported platinum catalysts (Pt/C)) for oxygen reduction reactions (ORR) has limited the commercial and scalable use of fuel cells.

Moreover, the electrochemical performance of fuel cells is greatly affected by the ORR at the cathode because of its limited reaction kinetics. To efficiently catalyze the ORR, platinum-loaded carbons (e.g., Pt/C) have been the most commonly used electrocatalyst. However, the large-scale production of Pt/C for commercial applications has been hindered by the high cost of Pt as well as by the time-dependent drift and CO deactivation problems of Pt-based electrodes.

Consequently, efforts have been made to develop new ORR electrocatalyst alternatives to minimize or replace Pt. Examples include Pt-based alloys, inorganic/nanocarbon hybrid materials, and heterocyclic polymers. In particular, heteroatom (e.g., N, B, S and P) doped nanocarbon materials (e.g., carbon nanotubes, graphene, ordered mesoporous graphitic arrays, and carbon nanofibers) have attracted great interest due to their low-cost, high electrocatalytic activities, selectivity, and stability. Further, it was found that co-doping carbon with two heteroatoms, boron and nitrogen, can effectively create more catalytically active sites than singularly doped counterparts, resulting from synergistic coupling effects between heteroatoms.

Significant developments have also been made on zero-dimensional graphene quantum dots (GQD) associated with quantum-confinement and edge effects, leading to applications in photovoltaics, supercapacitors, bioimaging and sensors. The edge-abundant features of GQDs are particularly advantageous for electrocatalysts, as reactions are more readily electrochemically catalyzed at the edge planes than the basal planes.

Though nitrogen-doped GQDs have been demonstrated to be electrochemically active towards ORR, the enhanced electrocatalytic activity is limited. This may be due to the low electrical conductivity of the electrode made using small GQDs with high percolation threshold values.

Despite the aforementioned efforts, a need still exists to develop efficient catalysts that have comparable or superior performance to commercial catalysts, such as Pt/C. Various embodiments of the present disclosure address this need.

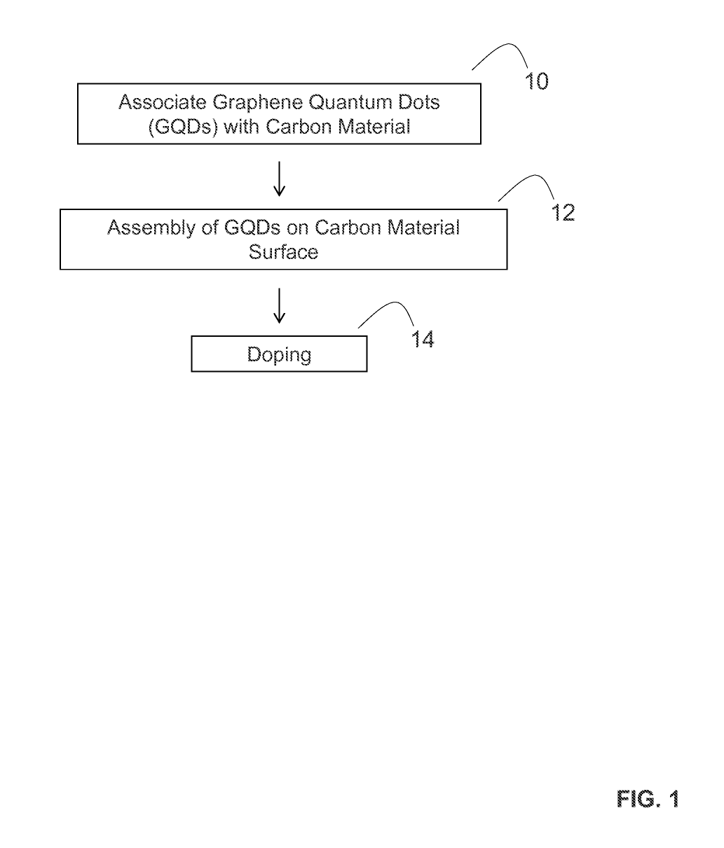

In some embodiments, the present disclosure pertains to methods of making a composite. In some embodiments illustrated in FIG. 1, the methods of the present disclosure include associating graphene quantum dots with a carbon material (step 10) to result in the assembly of the graphene quantum dots on a surface of the carbon material (step 12). In some embodiments, the methods of the present disclosure also include a step of doping the graphene quantum dots or the carbon materials with one or more dopants (step 14) to result in the formation of a doped composite. Additional embodiments of the present disclosure pertain to composites that are formed by the methods of the present disclosure.

As set forth in more detail herein, the methods and composites of the present disclosure can have numerous embodiments. For instance, various methods may be utilized to associate various types of graphene quantum dots with various types of carbon materials. Moreover, graphene quantum dots may be assembled on various surfaces of carbon materials in various manners. Furthermore, various methods may be utilized to dope graphene quantum dots and carbon materials with various dopants. In addition, the methods of the present disclosure can be utilized to form various types of composites for various applications.

Association of Graphene Quantum Dots with Carbon Materials

Various methods may be utilized to associate graphene quantum dots with a carbon material. For instance, in some embodiments, the association occurs by a method that includes, without limitation, mixing, stirring, sonication, freeze-drying, hydrothermal treatment, annealing, and combinations thereof.

In some embodiments, the association occurs by hydrothermal treatment. In some embodiments, the hydrothermal treatment includes the incubation of graphene quantum dots with a carbon material in an aqueous solution at high temperatures (e.g., temperatures above 100° C.). In some embodiments, the aqueous solution may be in a liquid form, a gaseous form, and combinations of such forms. In some embodiments, the hydrothermal treatment includes the autoclaving of graphene quantum dots with a carbon material. In some embodiments, the autoclaving occurs at temperatures of about 180° C.

In some embodiments, the association occurs by a freeze-drying method. In some embodiments, the freeze-drying method involves the mixing of the graphene quantum dots with a carbon material in an aqueous solution (e.g., water) to form a mixture, the freezing of the mixture, and the drying of the frozen mixture.

Graphene quantum dots can be associated with a carbon material at various mass ratios. For instance, in some embodiments, the association occurs at a graphene quantum dot:carbon material mass ratio of 1:1. In some embodiments, the association occurs at a graphene quantum dot:carbon material mass ratio of 2:1. In some embodiments, the association occurs at a graphene quantum dot:carbon material mass ratio of 3:1. In some embodiments, the association occurs at a graphene quantum dot:carbon material mass ratio of 10:1. In some embodiments, the association occurs at a graphene quantum dot:carbon material mass ratio of 1:2. In some embodiments, the association occurs at a graphene quantum dot:carbon material mass ratio of 1:3. In some embodiments, the association occurs at a graphene quantum dot:carbon material mass ratio of 1:10. Additional mass ratios can also be envisioned.

Assembly of Graphene Quantum Dots on Surfaces of Carbon Materials

Graphene quantum dots may be assembled on surfaces of carbon materials by various methods and in various manners. For instance, in some embodiments, graphene quantum dots may be assembled on surfaces of carbon materials through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof. In some embodiments, graphene quantum dots are assembled on a surface of a carbon material through self-assembly.

In some embodiments, a carbon material may serve as a two-dimensional template to direct the assembly of graphene quantum dots on its surface. In some embodiments, the assembly of graphene quantum dots on a surface of a carbon material may be facilitated by interactions of functional groups associated with graphene quantum dots with functional groups associated with carbon materials. For instance, in some embodiments, strong interactions between hydroxyl and carbonyl functional groups of carbon materials and graphene quantum dots can ensure compact packing between the graphene quantum dots and the carbon materials.

The graphene quantum dots of the present disclosure may be assembled on various surfaces of carbon materials. For instance, in some embodiments, the surface includes, without limitation, an edge of a carbon material, a front surface of a carbon material, a back surface of a carbon material, on folds of a carbon material, and combinations of such surfaces.

Graphene Quantum Dots

The methods and composites of the present disclosure can utilize various types of graphene quantum dots. For instance, in some embodiments, the graphene quantum dots of the present disclosure can include, without limitation, unfunctionalized graphene quantum dots, functionalized graphene quantum dots, graphene oxide quantum dots, graphene oxide nanoribbon quantum dots, graphene nanoribbon quantum dots, coal-derived graphene quantum dots, coke-derived graphene quantum dots, biochar-derived graphene quantum dots, and combinations thereof.

The graphene quantum dots of the present disclosure may be derived from various sources. For instance, in some embodiments that are described in more detail herein, the graphene quantum dots of the present disclosure may be derived from at least one of coal (e.g., asphalt or asphaltenes), coke, biochar, and combinations thereof.

In some embodiments, the graphene quantum dots of the present disclosure are unfunctionalized. In some embodiments, the graphene quantum dots of the present disclosure are functionalized with a plurality of functional groups. In some embodiments, the functional groups include, without limitation, amorphous carbons, oxygen groups, carbonyl groups, carboxyl groups, hydroxyl groups, esters, amines, amides, alkyls (e.g., alkyl groups), aromatics, and combinations thereof.

In some embodiments, the graphene quantum dots of the present disclosure are edge functionalized with a plurality of functional groups. For instance, in some embodiments, the graphene quantum dots of the present disclosure include oxygen addends on their edges. In some embodiments, the graphene quantum dots of the present disclosure include amorphous carbon addends on their edges.

The graphene quantum dots of the present disclosure can have various diameters. For instance, in some embodiments, the graphene quantum dots of the present disclosure include diameters ranging from about 1 nm to about 100 nm. In some embodiments, the graphene quantum dots of the present disclosure include diameters ranging from about 10 nm to about 50 nm. In some embodiments, the graphene quantum dots of the present disclosure include diameters ranging from about 1 nm to about 5 nm. In some embodiments, the graphene quantum dots of the present disclosure include diameters ranging from about 2 nm to about 10 nm.

The graphene quantum dots of the present disclosure may also have various structures. For instance, in some embodiments, the graphene quantum dots of the present disclosure include a crystalline hexagonal structure. In some embodiments, the graphene quantum dots of the present disclosure are in the form of flakes. In some embodiments, the graphene quantum dots of the present disclosure have a disc-like structure. In some embodiments, the graphene quantum dots of the present disclosure have amorphous regions in the structure. Additional structures can also be envisioned.

The graphene quantum dots of the present disclosure may also have various layers. For instance, in some embodiments, the graphene quantum dots of the present disclosure include a single layer. In some embodiments, the graphene quantum dots of the present disclosure include a plurality of layers. In some embodiments, the graphene quantum dots of the present disclosure include from about two layers to about ten layers. In some embodiments, the graphene quantum dots of the present disclosure include from about two layers to about four layers.

Various methods may be utilized to form the graphene quantum dots of the present disclosure. For instance, in some embodiments, graphene quantum dots of the present disclosure can be made by exposing various carbon sources to various oxidants. In some embodiments, the graphene quantum dots of the present disclosure are formed by exposing a coal to an oxidant. In some embodiments, the coal includes, without limitation, anthracite coal, bituminous coal, sub-bituminous coal, metamorphically altered bituminous coal, asphaltenes, asphalt, peat, lignite, steam coal, petrified oil, and combinations thereof. In some embodiments, the graphene quantum dots of the present disclosure are formed by exposing coke to an oxidant.

In some embodiments, the graphene quantum dots of the present disclosure are formed by exposing a biochar to an oxidant. In some embodiments, the biochar includes, without limitation, applewood biochar, mesquite biochar, pyrolyzed biochar, cool terra biochar, and combinations thereof. The aforementioned methods of forming graphene quantum dots are described in more detail in Applicants' publications and co-pending patent applications. See, e.g., Nat. Comm. 2013, 4, 2943. Also see PCT/US2014/036604 and U.S. Provisional Patent Application No. 62/076,394.

The graphene quantum dots of the present disclosure can form various arrangements on the surfaces of carbon materials. For instance, in some embodiments, the graphene quantum dots of the present disclosure are dispersed on a surface of a carbon material. In some embodiments, the graphene quantum dots of the present disclosure are randomly dispersed on a surface of a carbon material. In some embodiments, the graphene quantum dots of the present disclosure are aggregated on a surface of a carbon material. In some embodiments, the graphene quantum dots of the present disclosure are dispersed and aggregated on a surface of a carbon material. In some embodiments, the graphene quantum dots of the present disclosure form an interconnected network on a surface of the carbon material. Additional arrangements can also be envisioned.

Carbon Materials

The methods and composites of the present disclosure can utilize various types of carbon materials. For instance, in some embodiments, the carbon materials of the present disclosure can include, without limitation, graphite, graphite oxide, graphene, graphene oxide, graphene nanoribbons, graphene oxide nanoribbons, carbon nanofibers, carbon nanotubes, split carbon nanotubes, activated carbon, carbon black, functionalized carbon materials, pristine carbon materials, doped carbon materials, reduced carbon materials, stacks thereof, and combinations thereof.

In some embodiments, the carbon materials of the present disclosure include graphene oxide. In some embodiments, the carbon materials of the present disclosure include reduced graphene oxides. In some embodiments, the carbon materials of the present disclosure include graphene. In some embodiments, the carbon materials of the present disclosure include conjugated domains. In some embodiments, the conjugated domains include double bonds with pi interactions.

In some embodiments, the carbon materials of the present disclosure are unfunctionalized. In some embodiments, the carbon materials of the present disclosure are functionalized with a plurality of functional groups. In some embodiments, the functional groups include, without limitation, amorphous carbons, oxygen groups, carbonyl groups, carboxyl groups, hydroxyl groups, esters, amines, amides, alkyls, (e.g., alkyl groups), aromatics, and combinations thereof.

The carbon materials of the present disclosure may also have various structures. For instance, in some embodiments, the carbon materials of the present disclosure are in the form of flakes. In some embodiments, the carbon materials of the present disclosure are in the form of sheets. In some embodiments, the carbon materials of the present disclosure are in the form of films. Additional structures can also be envisioned.

The carbon materials of the present disclosure may also have various layers. For instance, in some embodiments, the carbon materials of the present disclosure include a single layer. In some embodiments, the carbon materials of the present disclosure include a plurality of layers. In some embodiments, the carbon materials of the present disclosure include from about two layers to about ten layers. In some embodiments, the carbon materials of the present disclosure include from about two layers to about four layers.

In some embodiments, the carbon materials of the present disclosure include stacked layers of carbon materials. For instance, in some embodiments, the carbon materials of the present disclosure include stacked layers of graphene, stacked layers of graphene nanoribbons, and combinations thereof.

Doping

In some embodiments, the methods of the present disclosure may also include a step of doping at least one of the graphene quantum dots and the carbon material with one or more dopants. In some embodiments, the doping results in the formation of a doped composite.

Doping can occur by various methods. For instance, in some embodiments, doping can occur by spraying, sputtering, chemical vapor deposition, annealing, and combinations of such steps. Additional doping methods can also be envisioned.

In some embodiments, the doping occurs by annealing. Annealing can occur under various conditions. For instance, in some embodiments, the annealing can occur at temperatures that range from about 100° C. to about 2,000° C. In some embodiments, the annealing can occur at temperatures that range from about 500° C. to about 1,500° C. In some embodiments, the annealing occurs at temperatures that range from about 800° C. to about 1,000° C. In some embodiments, the annealing occurs at a temperature of about 1,000° C.

Annealing can also occur for various periods of time. For instance, in some embodiments, the annealing occurs from about 5 seconds to about 180 minutes. In some embodiments, the annealing occurs from about 1 minute to about 120 minutes. In some embodiments, the annealing occurs from about 10 minutes to about 100 minutes. In some embodiments, the annealing occurs for about 10 minutes, for about 30 minutes, or for about 60 minutes.

Doping can occur during various steps. For instance, in some embodiments, the doping occurs prior to associating the graphene quantum dots with the carbon material. In some embodiments, the doping occurs before associating the graphene quantum dots with the carbon material. In some embodiments, the doping occurs during associating the graphene quantum dots with the carbon material (e.g., doping during hydrothermal treatment). In some embodiments, the doping occurs after associating the graphene quantum dots with the carbon material. In some embodiments, the doping occurs during and after associating the graphene quantum dots with the carbon material.

The graphene quantum dots and carbon materials of the present disclosure may be doped with various dopants. For instance, in some embodiments, the dopant includes, without limitation, boron, nitrogen, oxygen, aluminum, gold, phosphorous, silicon, sulfur, metals, metal oxides, transition metals, transition metal oxides, heteroatoms thereof, and combinations thereof. In some embodiments, the dopant includes boron and nitrogen. In some embodiments, the dopant includes, without limitation, melamine, carboranes, aminoboranes, phosphines, aluminum hydroxides, manganese oxides (e.g., MnO₂), cobalt oxides (e.g., Co₃O₄), silanes, polysilanes, polysiloxanes, sulfides, thiols, and combinations thereof. In some embodiments, the dopant includes ammonia and boric acid as nitrogen and boron sources, respectively.

Doping can result in the formation of various types of doped composites. For instance, in some embodiments, doping results in the formation of edge-doped composites. In some embodiments, doping results in the formation of composites with dopants that are dispersed on a surface of the composite. In some embodiments, doping results in the formation of composites with dopants that are aggregated on a surface of the composite. In some embodiments, doping results in the formation of composites with dopants that are aggregated and dispersed on a surface of the composite. In some embodiments, doping results in the formation of composites with dopants that form an interconnected network on a surface of the composite.

In some embodiments, doping results in the formation of composites with dopants inserted interstitial to the carbon material (e.g., graphene) or graphene quantum dots. In some embodiments, the interstitial insertion of dopants can replace some of the carbon atoms in the carbon material (e.g., carbon atoms in a two dimensional graphene framework) or the graphene quantum dots. In some embodiments, the interstitial insertion of dopants can replace the carbon material itself.

Composites

The methods of the present disclosure can be utilized to form various types of composites. Additional embodiments of the present disclosure pertain to the composites that are formed by the methods of the present disclosure.

In some embodiments, the composites of the present disclosure include graphene quantum dots and a carbon material, where the graphene quantum dots are assembled on a surface of the carbon material. In some embodiments, the composites of the present disclosure may be doped with one or more dopants.

As set forth previously, the composites of the present disclosure can contain various types of carbon materials and graphene quantum dots in various assembled arrangements. As also set forth previously, the composites of the present disclosure may be doped with various types of dopants. As set forth in more detail herein, the composites of the present disclosure can have various shapes, properties, and applications.

Composite Structures

The composites of the present disclosure can have various structures. For instance, in some embodiments, the composites of the present disclosure are in the form of flake-like structures. In some embodiments, the composites of the present disclosure are in the form of nanoplatelets. In some embodiments, the composites of the present disclosure are in the form of flat sheets.

The composites of the present disclosure can also have various thicknesses. For instance, in some embodiments, the composites of the present disclosure have a thickness ranging from about 5 nm to about 1 μm. In some embodiments, the composite has a thickness ranging from about 5 nm to about 10 nm. In some embodiments, the composites of the present disclosure have a thickness of about 7 nm.

The composites of the present disclosure can also have various surface areas. For instance, in some embodiments, the composites of the present disclosure have surface areas that range from about 10 m²/g to about 1,000 m²/g. In some embodiments, the composites of the present disclosure have surface areas that range from about 100 m²/g to about 800 m²/g. In some embodiments, the composites of the present disclosure have surface areas that range from about 200 m²/g to about 500 m²/g. In some embodiments, the composites of the present disclosure have a surface area of about 400 m²/g.

The composites of the present disclosure can also have various contents. For instance, in some embodiments, the composites of the present disclosure have a boron content ranging from about 5% by weight to about 20% by weight. In some embodiments, the composites of the present disclosure have a nitrogen content ranging from about 5% by weight to about 20% by weight. In some embodiments, the composites of the present disclosure have an oxygen content ranging from about 5% by weight to about 20% by weight.

Composite Properties

The composites of the present disclosure can have various advantageous properties. For instance, in some embodiments, the composites of the present disclosure are capable of mediating oxygen reduction reactions, oxygen evolution reactions, hydrogen oxidation reactions, hydrogen evolution reactions, and combinations of such reactions.

In some embodiments, the composites of the present disclosure have a higher current density than commercially available Pt/C. In some embodiments, the composites of the present disclosure demonstrate a more positive onset potential than commercially available Pt/C. For instance, in some embodiments, the composites of the present disclosure demonstrate about 15 mV more positive onset potential and similar current density when compared to commercial Pt/C.

In some embodiments, the composites of the present disclosure have a current density that ranges from about 1 mA/cm² to about 15 mA/cm². In some embodiments, the composites of the present disclosure have a current density that ranges from about 2 mA/cm² to about 4 mA/cm².

In some embodiments, the composites of the present disclosure have an electron transfer number that ranges from about 1 to about 4. In some embodiments, the composites of the present disclosure have an electron transfer number that ranges from about 3 to about 4.

Applications of Composites

In view of the aforementioned advantageous properties, the composites of the present disclosure can be used for various applications. For instance, in some embodiments, the composites of the present disclosure can be utilized as electrocatalysts for mediating oxygen reduction reactions, oxygen evolution reactions, hydrogen oxidation reactions, hydrogen evolution reactions, and combinations of such reactions. In some embodiments, the composites of the present disclosure can be used as bi-functional electrocatalysts for oxygen reduction reactions and oxygen evolution reactions.

In some embodiments, the composites of the present disclosure can be used as components of energy storage devices. In some embodiments, the composites of the present disclosure can be used as components of a battery, such as lithium ion batteries, zinc-air batteries, lithium-oxygen batteries, supercapacitors, pseudocapacitors, microsupercapacitors, and combinations thereof.

### ADDITIONAL EMBODIMENTS

Reference will now be made to more specific embodiments of the present disclosure and experimental results that provide support for such embodiments. However, Applicants note that the disclosure below is for illustrative purposes only and is not intended to limit the scope of the claimed subject matter in any way.

### Example 1

### Boron- and Nitrogen-Doped Graphene Quantum Dots/Graphene Hybrid Nanoplatelets as Efficient Electrocatalysts for Oxygen Reduction

In this Example, Applicants demonstrate that graphene quantum dots synthesized from inexpensive and earth abundant anthracite coal were self-assembled on graphene by hydrothermal treatment to form hybrid nanoplatelets that were then co-doped with nitrogen and boron by high temperature annealing. Here, Applicants first synthesized graphene quantum dots/graphene (GQD/G) hybrid nanoplatelets by hydrothermal self-assembly and then co-doped the GQD/G with boron and nitrogen to obtain BN-doped GQD/G(BN-GQD/G) hybrid nanoplatelets by annealing at high temperature for different time periods. This hybrid material combined the advantages of both components, such as abundant edges and doping sites, high electrical conductivity, and high surface area. The hybrid materials demonstrated optimal ORR electrocatalytic activity with more positive onset potential than commercial Pt/C. The hybrid materials also demonstrated large current densities.

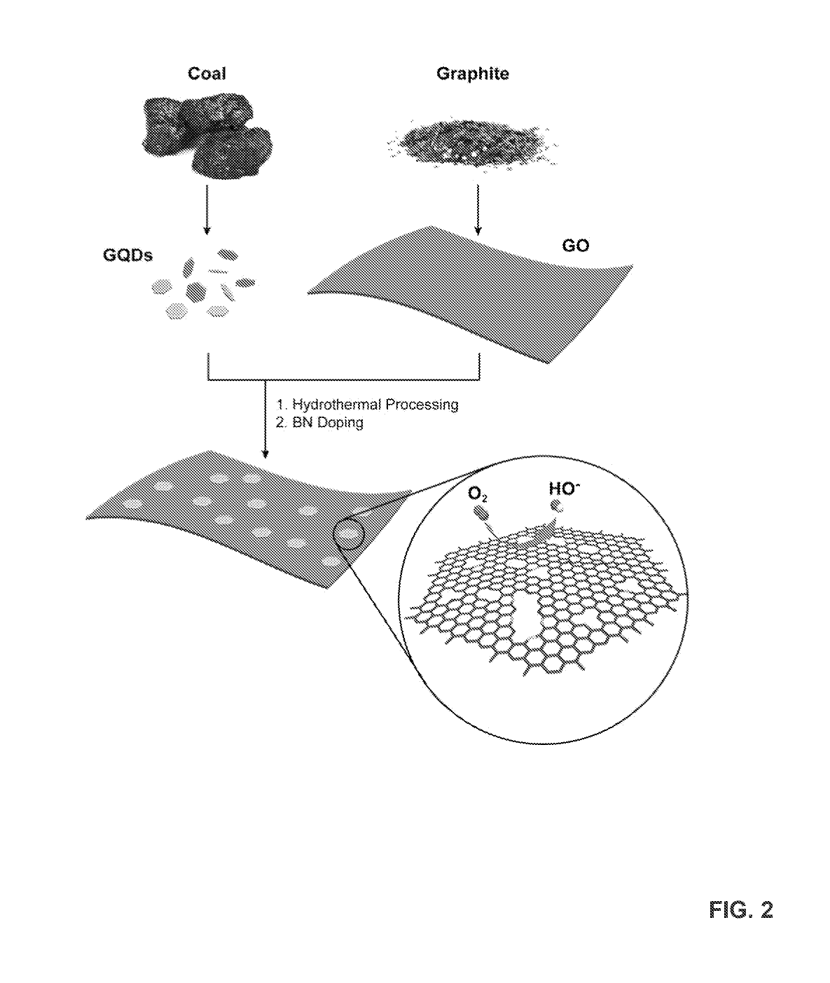

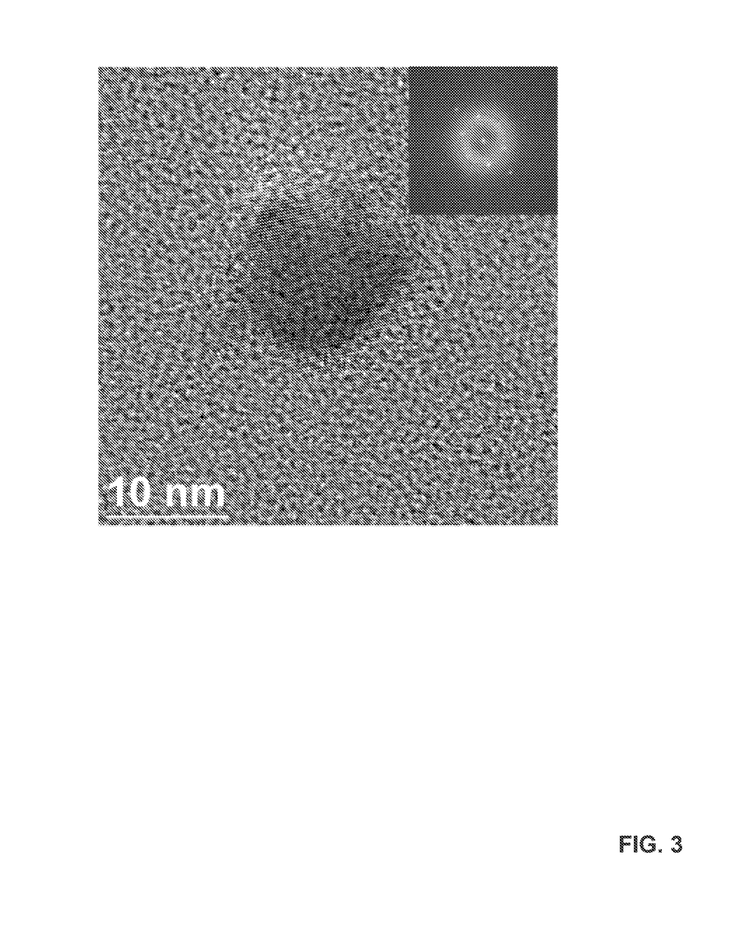

The preparation of BN-GQD/G is illustrated in FIG. 2. The GQD were synthesized through a facile and inexpensive method, recently developed by Applicants, by oxidizing anthracite coal in H₂SO₄/HNO₃ acid (see Example 1.1 and Nat. Comm. 2013, 4, 2943). The GQDs were readily dispersible in water. A typical transmission electron microscopy (TEM) image of GQDs is shown in FIG. 3 with a size of about 15 nm to about 20 nm. The GQDs were mixed with an aqueous suspension of graphene oxide (GO) at a mass ratio of 2:1 and hydrothermally treated for 14 hours. During the hydrothermal self-assembly process, GO with high surface area acted as a two-dimensional template to direct the assembly of GQDs. The strong interactions between the hydroxyl and carbonyl functional groups of GO and GQDs ensured the compact packing between them, leading to the formation of GQD/G hybrid nanoplatelets.

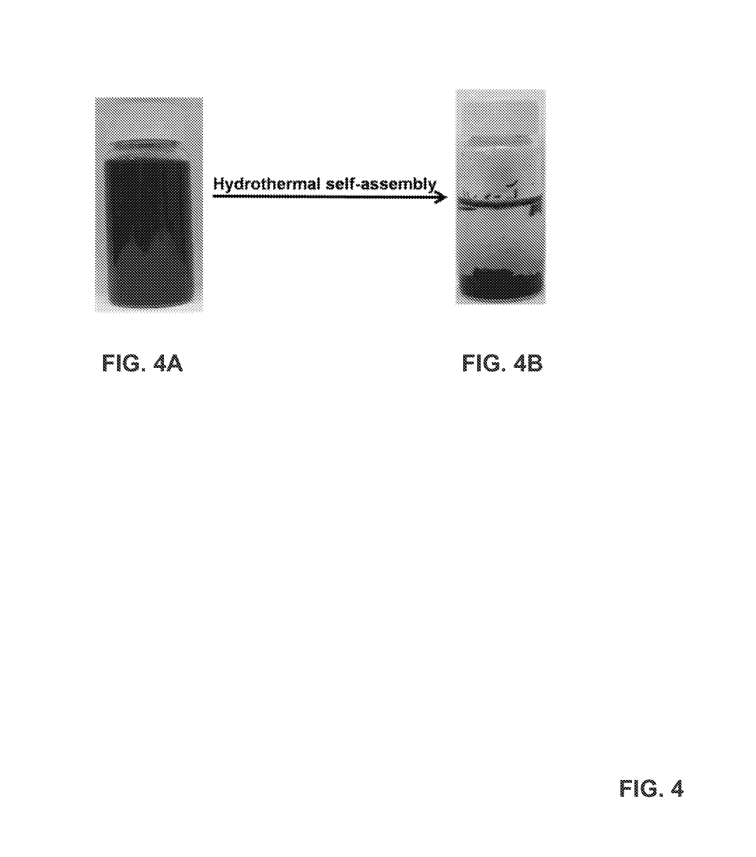

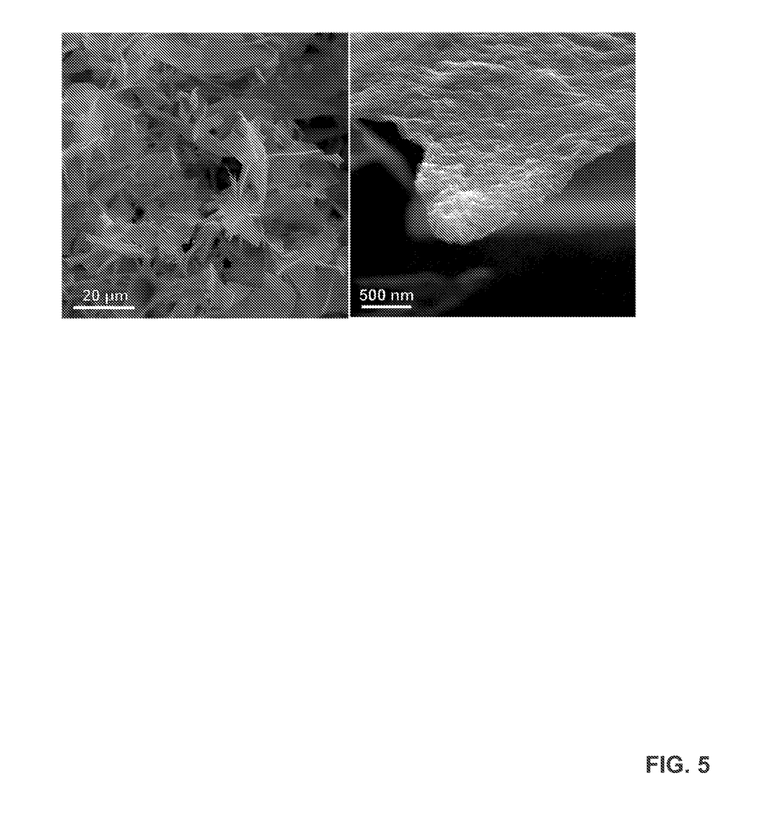

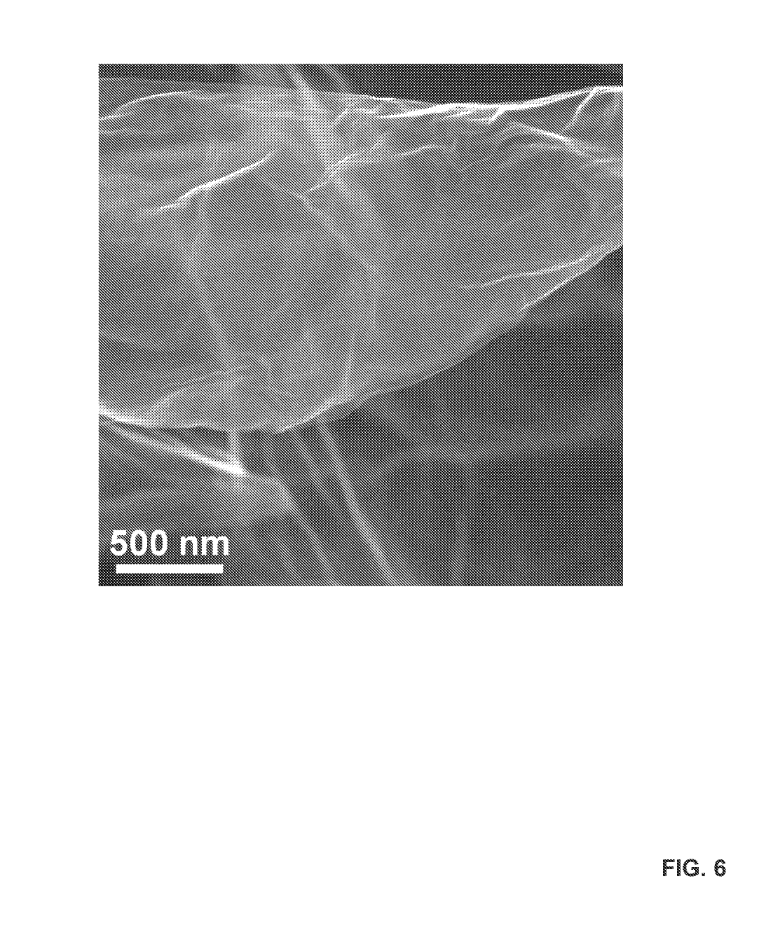

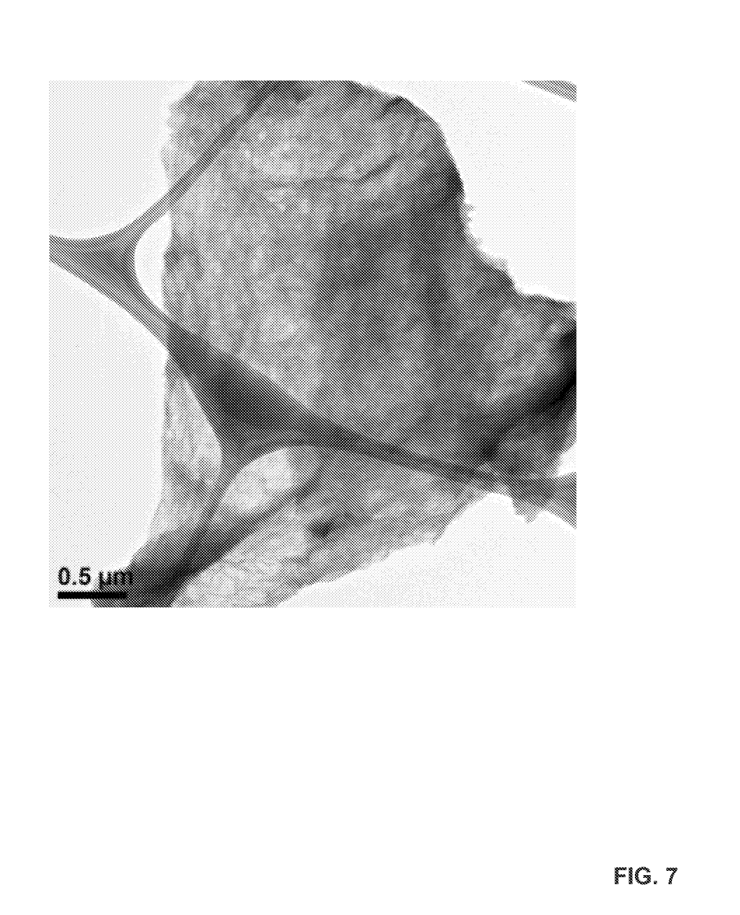

After the aforementioned self-assembly process, the mixture precipitated (FIG. 4), indicating that the hydrothermal process reduced the GQDs and GO, rendering them insoluble and allowing efficient assembly between GQDs and GO. The morphology of the resulting GQD/G hybrid nanoplatelets was examined by scanning electron microscopy (SEM) and TEM. SEM images (FIG. 5) clearly show the uniform flake-like structure with dimensions similar to the graphene sheets, but the surface observed from the higher magnification SEM image appears to be rougher when compared to that of graphene alone (FIG. 6) due to the decoration of particle-like GQD on the reduced GO sheets. The formation of the flake-like structure was further confirmed by TEM (FIG. 7).

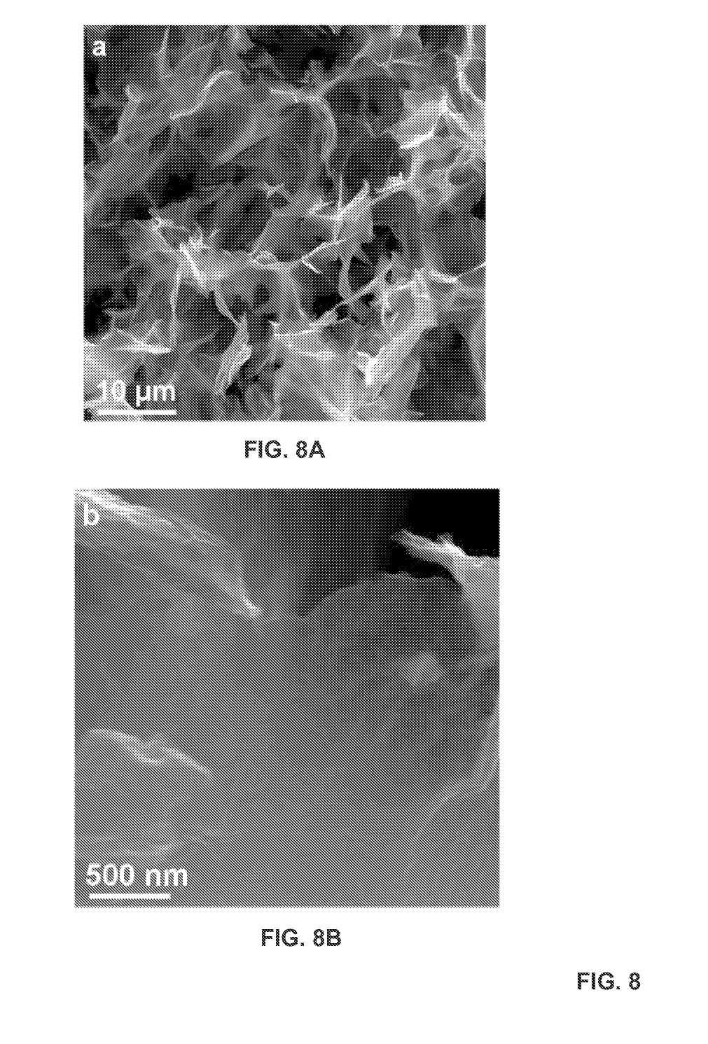

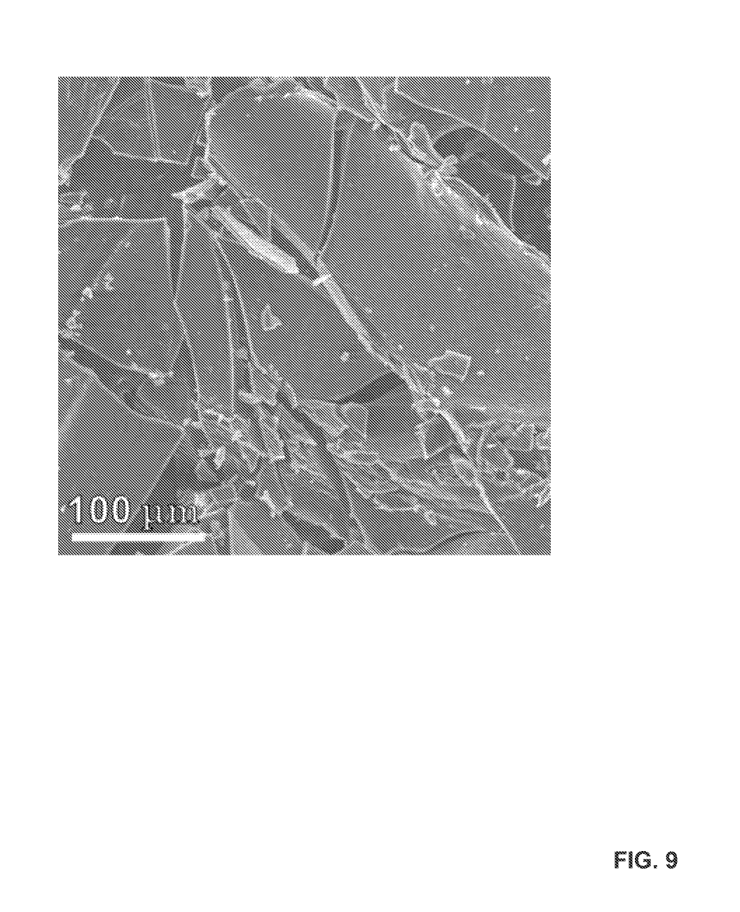

The mass ratio of GQD to GO was found to be important in the formation of flake-like structures. For example, when the GQD:GO ratio was decreased to 1:1, the flake-like structures were more graphene-like (FIG. 8). However, when the ratio was increased to 3:1, severe aggregation took place (FIG. 9) and no flake-like structures were observed. Without being bound by theory, Applicants envision that such observations may be due to the insufficient surface area provided by GO to support the GQDs when the GQD amount is excessive.

The GQD/G hybrid nanoplatelets were converted to BN-GQD/G by annealing at 1000° C. for different time periods using ammonia and boric acid as nitrogen and boron sources, respectively. The sample annealed for 10 minutes, 30 minutes and 60 minutes are denoted as BN-GQD/G-10, BN-GQD/G-30 and BN-GQD/G-60, respectively. Boron and nitrogen codoped graphene (BN-G-30), nitrogen doped GQD/G (N-GQD/G-30) and dopant-free (yet annealed) GQD/G (DF-GQD/G-30) were also prepared as control samples.

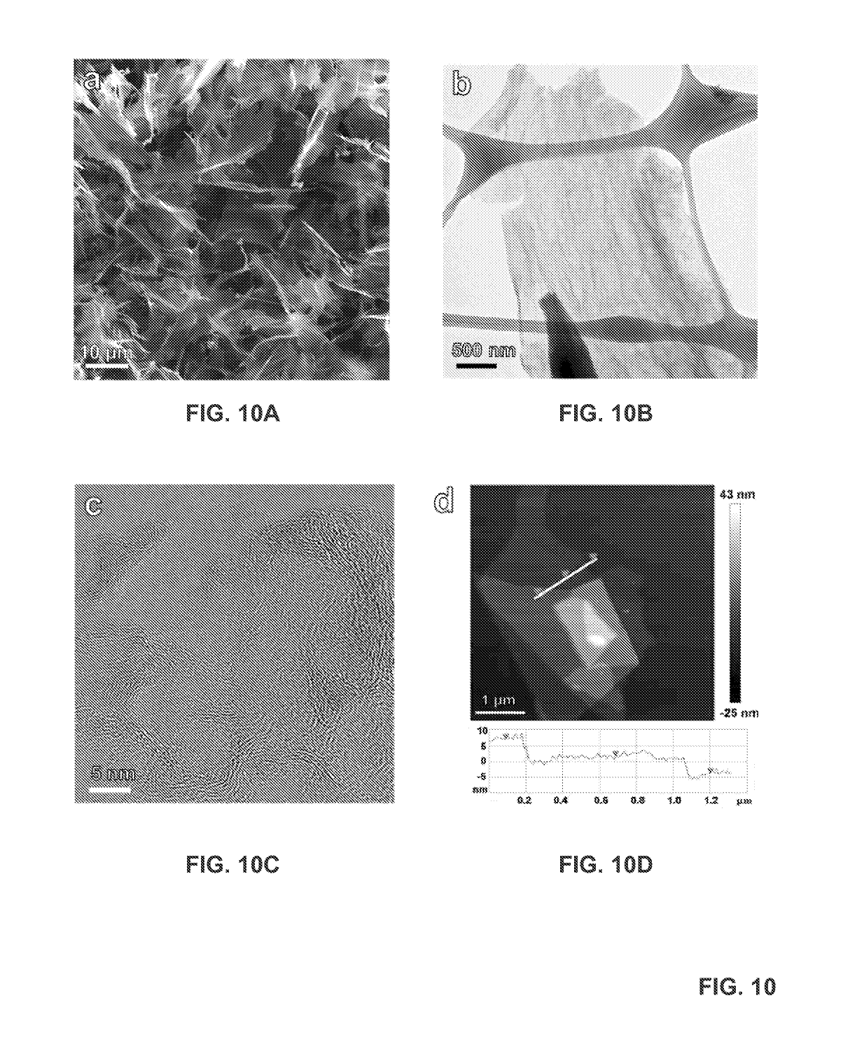

FIGS. 10A-B show the SEM and low magnification TEM images of BN-GQD/G-30. It can be seen that the flake-like structures were retained with no apparent aggregation after high temperature treatment at 1000° C. From high magnification TEM (FIG. 10C), small domains of defective graphitic structures were observed. The 2D features and thicknesses of the hybrid nanoplatelets were further characterized by AFM (FIG. 10D), which revealed that the average thicknesses of the flakes were ˜7 nm.

In the as-described architecture, graphene sheets not only behave as 2-D platforms to allow the uniform distribution of GQDs, but also because of their higher electrical conductivity, they act as conductive substrates for efficient electron transfer to interconnect the GQDs. The GQDs are too small to provide a sufficient percolative network for good conductivity. In addition, the porous scaffold formed by the flake-like BN-GQD/G hybrid nanoplatelets allows facile transport of electrolyte and electro-reactants/products. More importantly, GQDs with their abundant exposed edges and oxygen-containing functional groups allow the easy incorporation of dopants, which are potential active sites for electrocatalytic reactions. These factors together suggest BN-GQD/G with good ORR performances as will be discussed later.

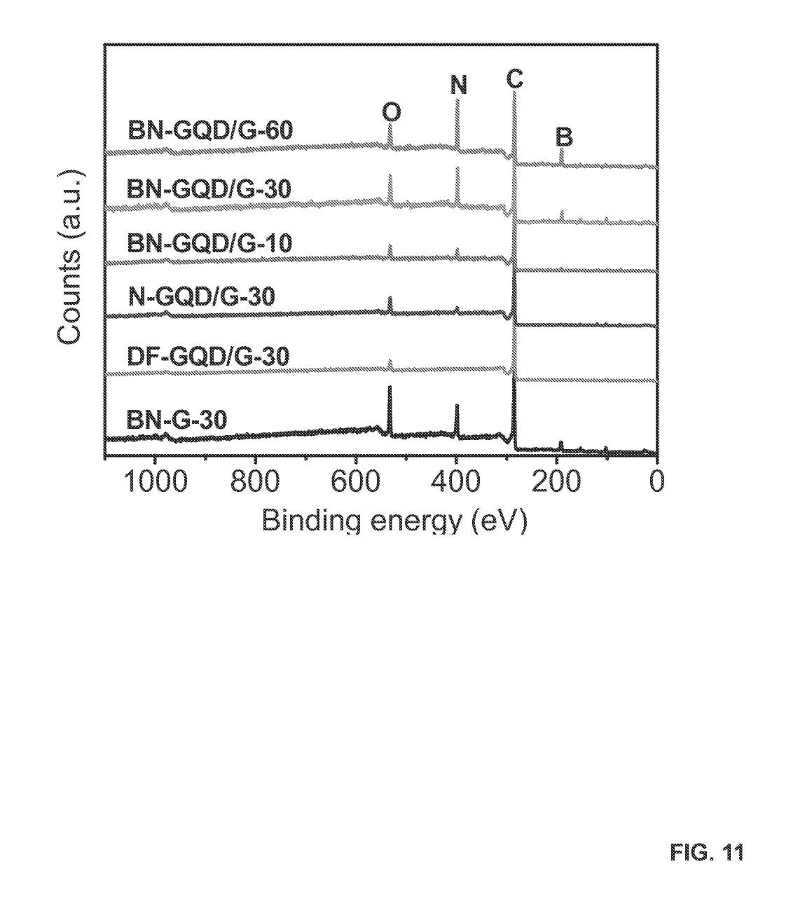

X-ray photoelectron spectroscopy (XPS) was used to determine the doping content and chemical state of nitrogen and boron in the BN-GQD/G samples. FIG. 11 shows the survey spectra of three BN-GQD/G samples with different doping times, along with BN-G-30, N-GQD/G-30 and dopant-free DF-GQD/G-30. In all of the BN-GQD/G samples, peaks characteristic of carbon, oxygen, boron and nitrogen are present, and the peaks for boron and nitrogen become more pronounced as the doping time increased.

The aforementioned results indicated that the BN doping process using boric acid and ammonia was effective, and that the doping contents can be tuned by varying the doping time. For example, 30 minutes of doping gave ˜18.3 at % nitrogen and ˜13.6 at % boron. In comparison, there was no boron in the N-GQD/G-30 sample, and both boron and nitrogen were absent in the DF-GQD/G-30. The chemical composition of these samples is summarized in Table 1.

TABLE 1
Atomic compositions of all studied
samples determined by XPS analysis.

Atomic composition (at %)

| Sample | C | O | N | B |
|---|---|---|---|---|
| BN-GQD/G-60 | 51.8 | 9.2 | 20.8 | 18.2 |
| BN-GQD/G-30 | 54.6 | 13.5 | 18.3 | 13.6 |
| BN-GQD/G-10 | 78.6 | 7.5 | 8.2 | 5.7 |
| N-GQD/G-30 | 85.7 | 9.9 | 4.3 | — |
| DF-GQD/G-30 | 94.2 | 5.8 | — | — |
| BN-G-30 | 58.3 | 13.9 | 14.5 | 13.3 |

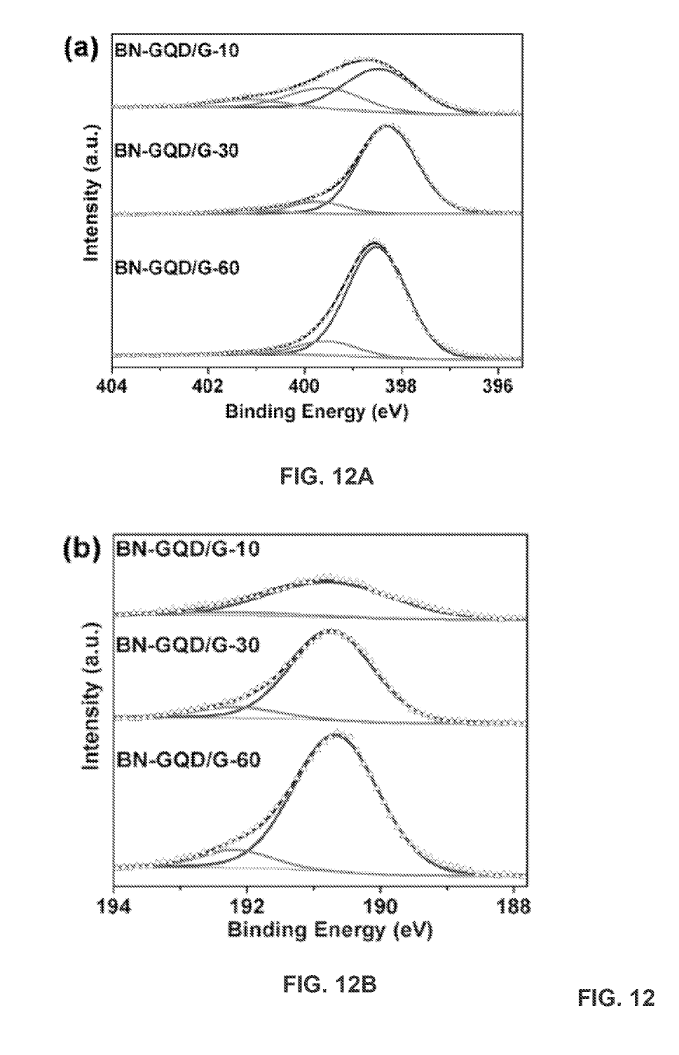

FIG. 12 shows the high resolution spectra of N is and B is for the BN-GQD/G samples. The N 1s spectra were deconvoluted into three peaks assignable to N—B bonding and pyridinic nitrogen (398.3 eV), pyrrolic nitrogen (399.8 eV) and quaternary nitrogen (401.1 eV). The B is spectra was deconvoluted into two peaks with one peak at 191.0 eV for N—B—C moieties and another at 192.3 eV for BCO₂ species. Analysis of the XPS data revealed that the N is and B is peaks are both dominated by N—B bonding species at 398.3 eV and 191.0 eV, respectively, and this dominance became more significant with the increase in doping time. This indicated that N and B tend to exist as pairs when the doping content was increased. The co-doping of N and B and their concentration will be shown to have important roles in affecting the ORR electrocatalytic activities.

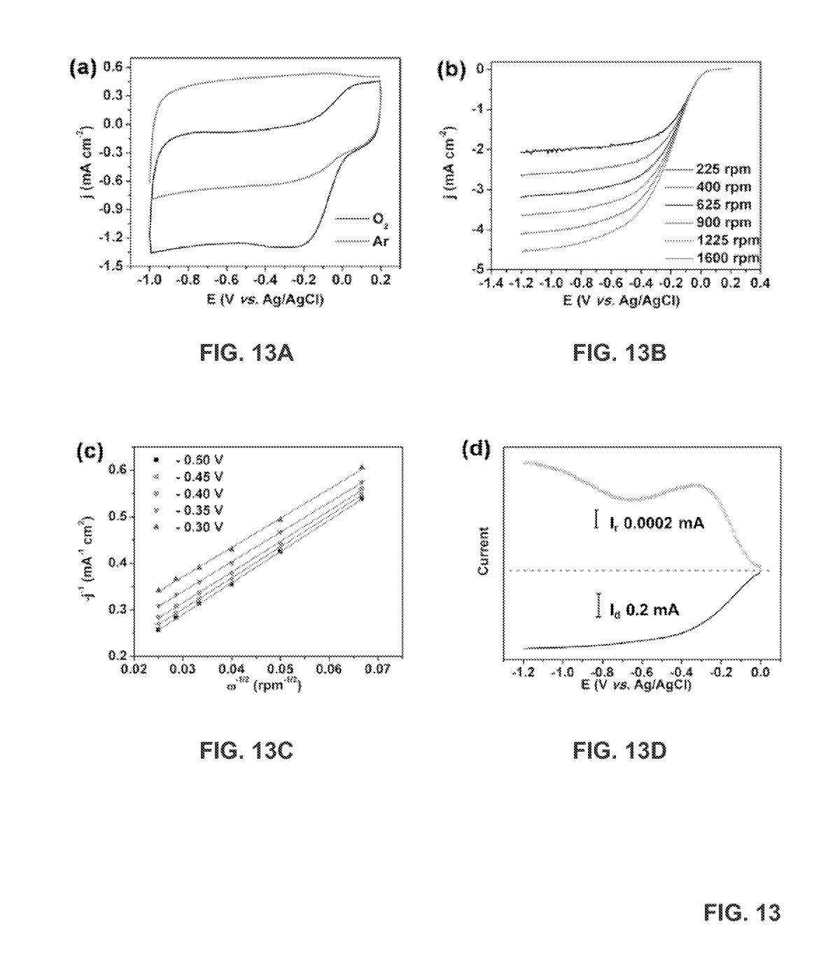

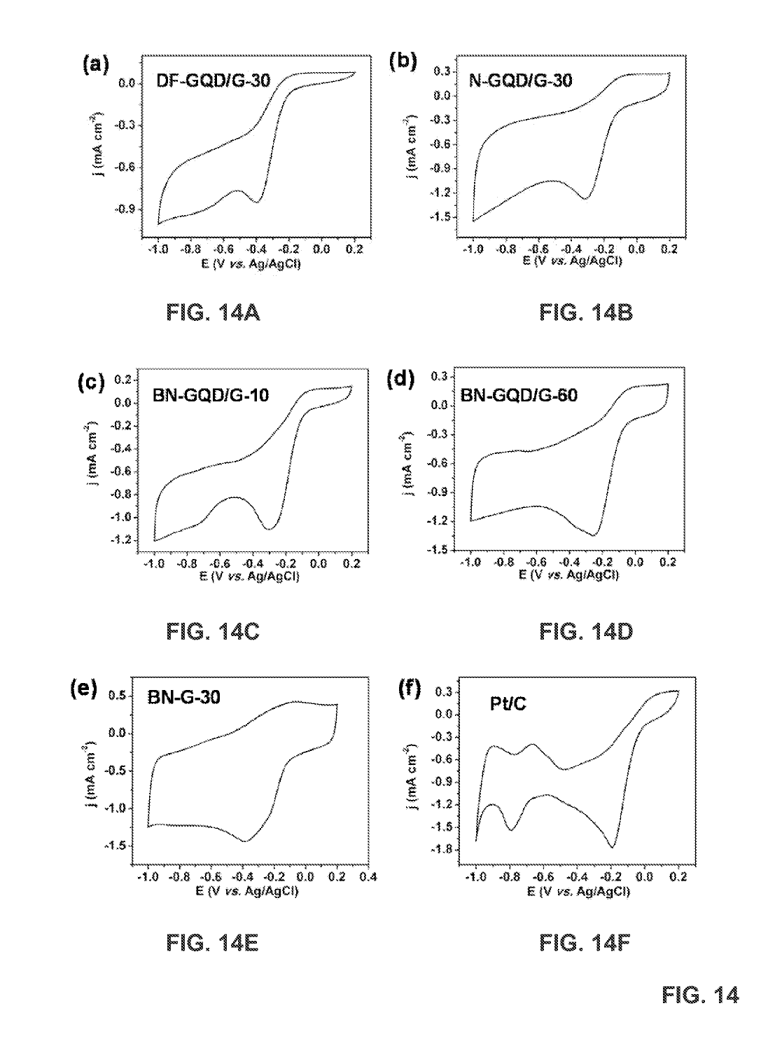

The ORR electrocatalytic properties were first examined by cyclic voltammetry (CV) in 0.1 M KOH solution saturated with Ar or O₂ within the potential range from 0.2 V to −1 V vs. Ag/AgCl at a scan rate of 100 mV s⁻¹. FIG. 13A shows the cyclic voltammograms for BN-GQD/G-30. It can be seen that a featureless current response was observed in Ar-saturated solution with large double-layer charge capacitance due to its high surface area. In strong contrast, a distinct cathodic peak appeared with substantial increase in current density when the solution was saturated with O₂, indicating pronounced catalytic activity toward ORR. In addition, the onset potential of BN-GQD/G-30 determined from CV was comparable to Pt/C (FIG. 14, both at ˜0 V).

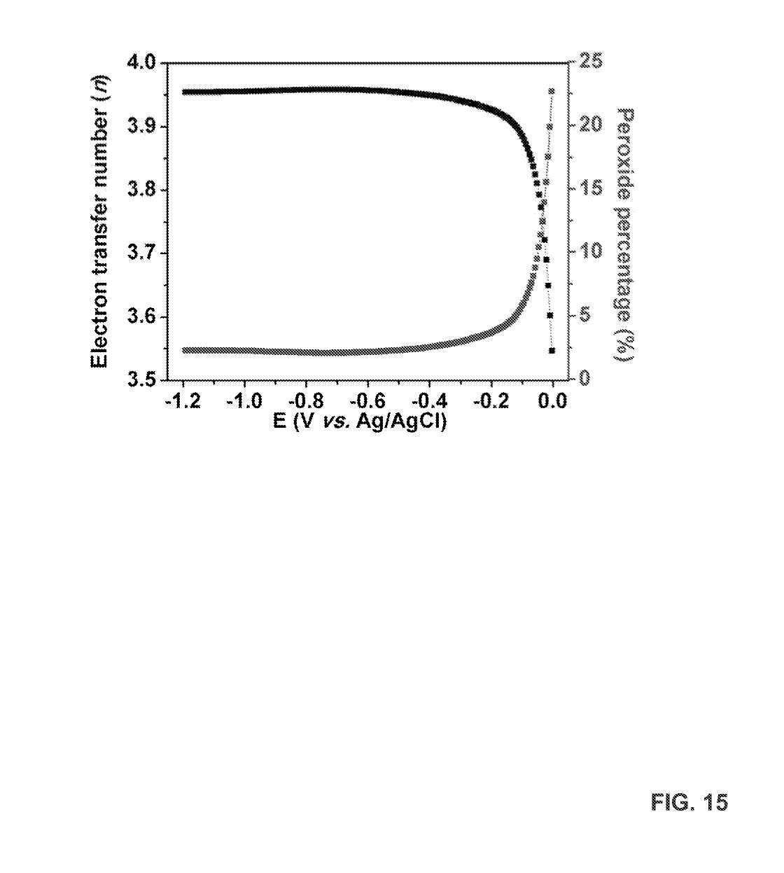

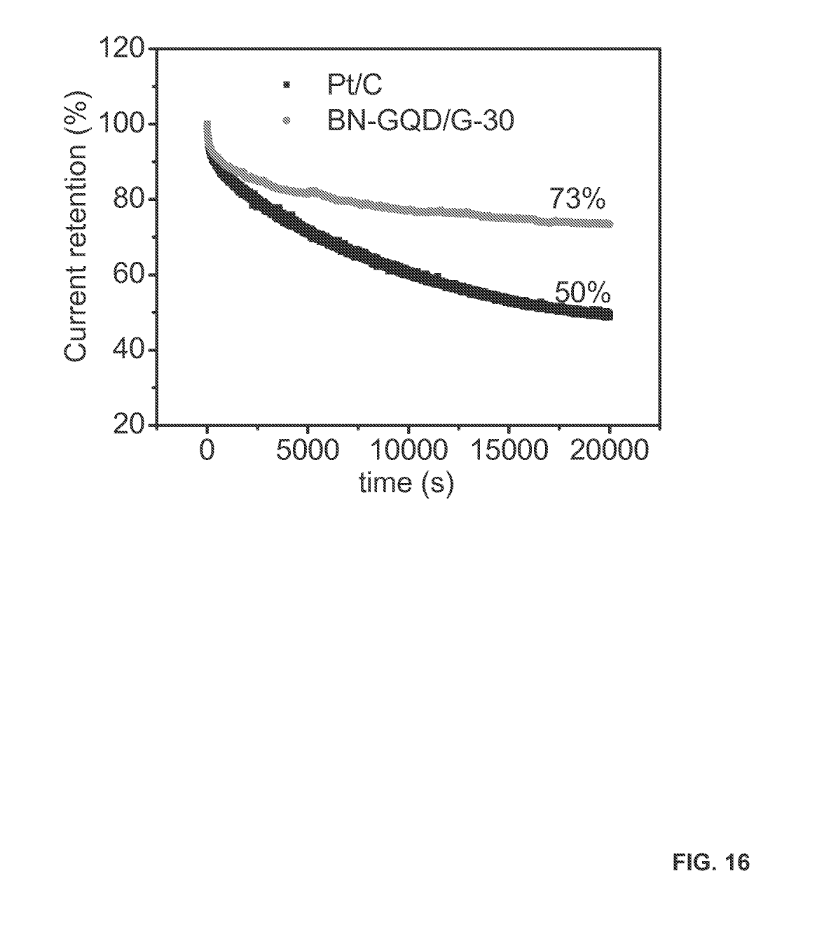

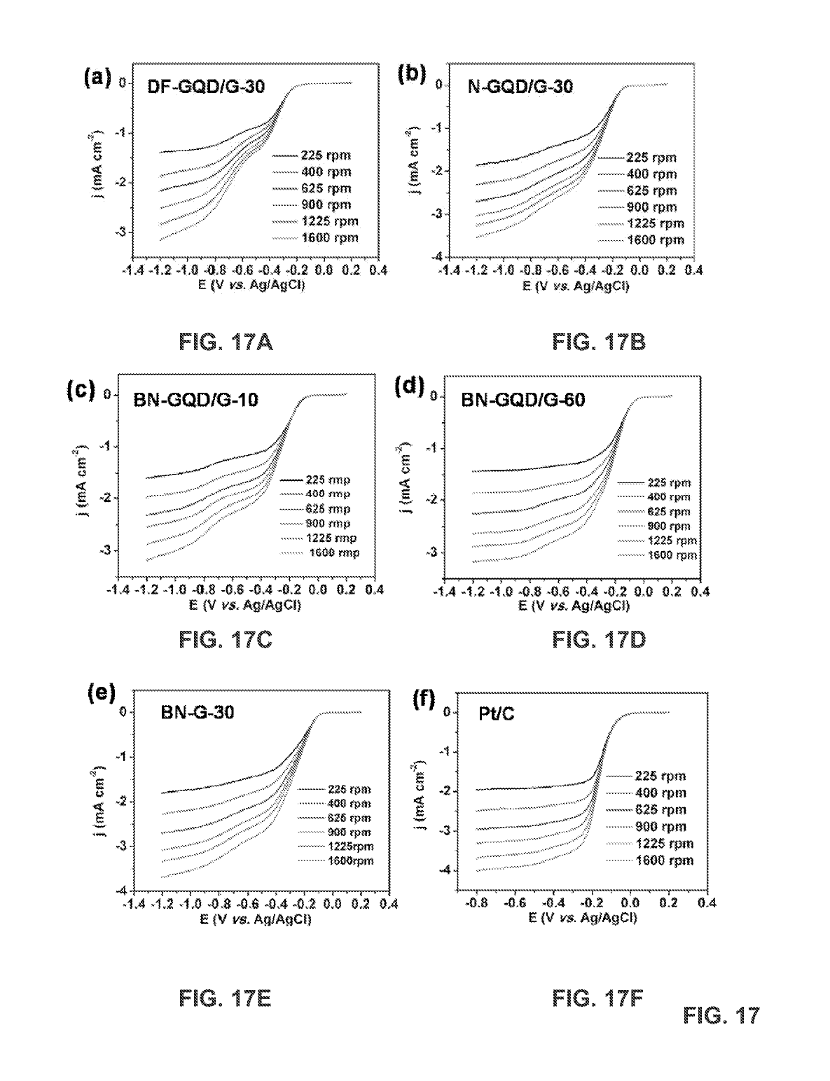

To gain further insight into the ORR, rotating disk electrode (RDE) voltammetry was performed in O₂-saturated 0.1 M KOH aqueous solution with a scan rate of 5 mV s⁻¹. FIG. 13B shows the RDE voltammograms for ORR of the BN-GQD/G-30 electrode at different rotating speeds. This data show typical increasing current densities with larger rotating speeds due to the shortened diffusion length at higher speeds. The kinetic parameters, including electron transfer numbers (n) and kinetic current density, were analyzed using the Koutecky-Levich (K-L) equations. The linearity of the K-L plots (j⁻¹ vs. ω^{-1/2}, FIG. 13C) and near parallelism of the fitting lines indicated first-order kinetics toward the concentration of dissolved O₂ and similar n values at different potentials. Remarkably, the average n for BN-GQD/G-30 hybrid nanoplatelets calculated from the slope of the K-L plots equals 3.93 in a potential range of −0.3 V to −0.5 V (FIG. 13C). This was further confirmed by a rotating ring disk electrode (RRDE) measurement that monitors the peroxide species (HO₂⁻) produced during the ORR process. The result (FIG. 13D) shows that the ring current (Iᵣ) was negligible compared to the disk current (I_{d}). The HO₂⁻ yield (FIG. 15) was below ˜4% over the potential range from −0.2 V to −0.12 V and gave an n of ˜3.95, suggesting a one step, four-electron oxygen reduction pathway. In addition, the durability of the BN-GQD/G-30 was examined using the chronoamperometric technique. Continuous operation at −0.3 V gives a 73% current retention after 20,000 s (FIG. 16), indicating its good stability in the alkaline medium. Cyclic and RDE voltammograms at different rotating speeds for the other samples (BN-GQD/G-10, BN-GQD/G-60, N-GQD/G-30, DF-GQD/G-30, BN-G-30 and commercial platinum on carbon black Pt/C) are in FIGS. 14 and 17.

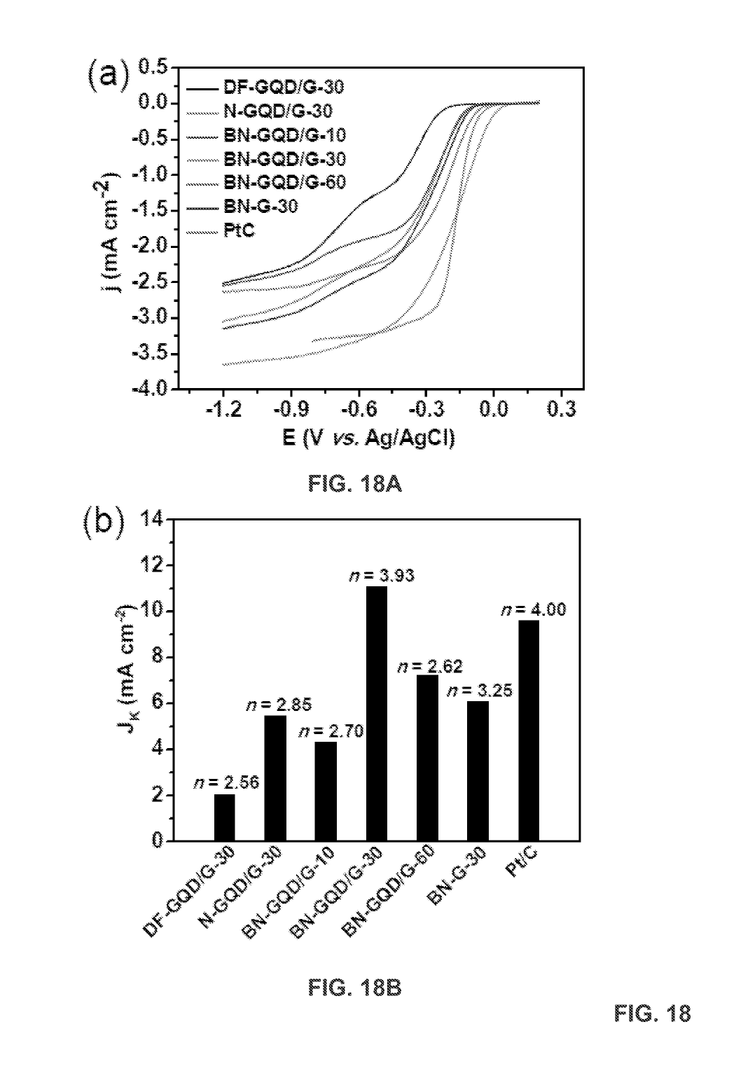

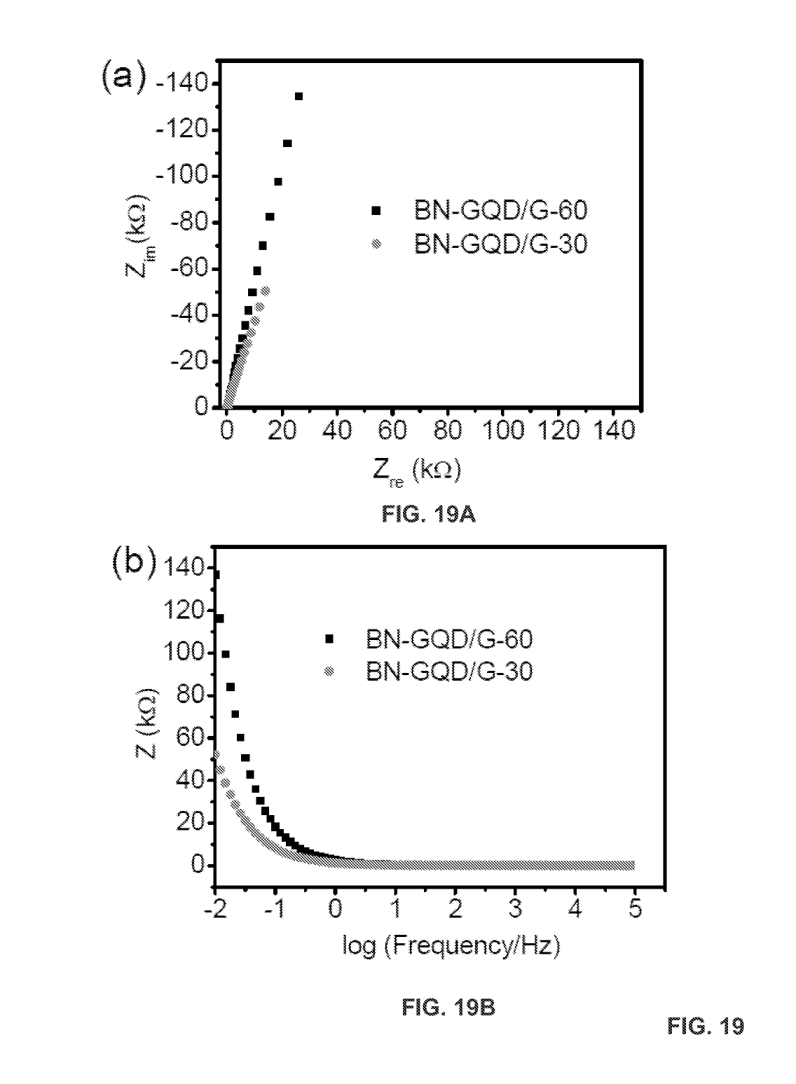

FIG. 18A shows the RDE voltammograms at 900 rpm for all samples. Except for the DF-GQD/G-30, which had a two-stage characterized ORR process, all other samples showed the typical one-stage processes, indicating the efficiency of incorporating dopants into the GQD/G hybrid nanoplatelets in enhancing ORR activity. Also, it was clear that the ORR activity was significantly influenced by doping time and the dopant concentration, with BN-GQD/G-30 having the most positive onset potential (0 V vs. Ag/AgCl) and largest current density through the entire potential range. The relatively lower ORR activities, less positive onset potentials, and smaller current densities of both BN-GQD/G-10 and BN-GQD/G-60 are supportive of the assertion that lower BN doping content results in a lower number of electrocatalytic sites. Likewise, higher BN doping content would produce B and N dopant pairs (as illustrated by the XPS analysis), which were found to be inactive towards ORR. In addition, excessive B and N doping would decrease the electrical conductivity as revealed by the impedance measurements (FIG. 19), which also contributes to the observed ORR activity degradation with the increase of doping time. To show the synergistic effects of dual B and N doping, N-GQD/G-30 was also included for comparison. It has a much more negative onset potential and smaller current density than BN-GQD/G-30 with the same doping time.

To show the role of GQD in improving ORR activity, BN-G-30 was tested. However, BNG-30 showed less optimal activity. When compared to commercial Pt/C, the onset potential of BN-GQD/G-30 measured from the RDE voltammograms was ˜15 mV more positive than that of Pt/C. In addition, the diffusion-limited current density and current density in the potential range of 0.20 V to −0.15 V of BN-GQD/G-30 was also larger than those of Pt/C at the same mass loading, suggesting the higher ORR activity of BN-GQD/G-30 than Pt/C.

FIG. 18B summarizes n and kinetic current densities (J_{K}) obtained from the K-L equation for all samples. BN-GQD/G-30 with its nearly full 4-electron ORR process (n=3.93) and large kinetic current (J_{K}=11.1 mA cm⁻²) outperformed DF-GQD/G-30 (n=2.56, J_{K}=2.1 mA cm⁻²), N-GQD/G-30 (n=2.62, J_{K}=5.4 mA cm⁻²), BN-G-30 (n=3.25, J_{K}=5.6 mA cm⁻²), BN-GQD/G-10 (n=2.70, J_{K}=4.3 mA cm⁻²) and BN-GQD/G-60 (n=2.62, J_{K}=7.2 mA cm⁻²), highlighting the importance of tuning doping concentration and the synergistic co-doping effects. More importantly, the kinetic current of BN-GQD/G-30 was even larger than that of Pt/C (J_{K}=9.6 mA cm⁻²).

In summary, with inexpensive and earth-abundant coal and graphite as raw materials, the low-cost production of boron and nitrogen co-doped graphene quantum dots/graphene hybrid nanoplatelets by hydrothermal reaction and post-annealing treatment was demonstrated. With enriched edge and BN doping sites from graphene quantum dots and high electrical conductivity from graphene, the optimized hybrid nanoplatelets exhibit optimal ORR activity with ˜15 mV more positive onset potential and similar current density when compared to commercial Pt/C.

### Example 1.1

### Synthesis of GO and GQD

GO was synthesized from graphite flakes (˜150 μm flakes) using the improved Hummers method (Marcano, D. C.; Kosynkin, D. V.; Berlin, J. M.; Sinitskii, A.; Sun, Z.; Slesarev, A.; Alemany, L. B.; Lu, W.; Tour, J. M. “Improved Synthesis of Graphene Oxide,” ACS Nano 2010, 4, 4806-4814.). GQDs were synthesized from anthracite using Applicants' published procedure (Nat. Comm. 2013, 4, 2943). Briefly, 300 mg of anthracite coal (Fisher Scientific, catalogue number 598806) was suspended in concentrated H₂SO₄/HNO₃ (60 mL: 20 mL) and then bath sonicated (Cole Parmer, model 08849-00) for 2 hours. The mixture was stirred and heated at 100° C. for 24 hours. The reaction was allowed to cool to room temperature and poured into a beaker containing 100 mL ice, followed by addition of NaOH (3 M) until the pH reached ˜7. The obtained mixture was then filtered through a 0.45 μm polytetrafluoroethylene (PTFE) membrane and the filtrate was dialyzed in a 1000 Da dialysis bag for 5 days.

### Example 1.2

### Synthesis of GQD/GO Hybrid Nanoplatelets

GQD/GO hybrid nanoplatelets were prepared by a hydrothermal process. In a typical process, 20 mg of GQD and 10 mg of GO were added to 5 mL DI water and bath-sonicated (Cole Parmer, model 08849-00) for 2 hours to form a stable aqueous suspension. The resulting mixture was sealed in a Telfon-lined autoclave and hydrothermally treated at 180° C. for 14 hours. Finally, the obtained samples were freeze-dried to obtain the powder product.

### Example 1.3

### Synthesis of BN-GQD/GO

The BN-doping process was performed using a CVD oven. Typically, GQD/GO was placed on a quartz boat in a standard 2.54 cm quartz tube furnace and solid boric acid was placed in a lower temperature zone as a boron source. Then, the quartz tube was evacuated to ˜100 mTorr and Ar/NH₃ (300 sccm:30 sccm) was turned on as a nitrogen source. After that, the temperature was increased to 1000° C. within 30 minutes and the reaction was allowed to proceed for another 10 minutes, 30 minutes, or 60 minutes to give BN-GQD/GO-10, BN-GQD/GO-30, and BN-GQD/GO-60, respectively. For comparison, DF-GQD/GO-30 and N-GQD/GO-30 were prepared using the same procedure with 30 minutes of doping except no BN or B sources were provided, respectively. BN-G was prepared using the same procedure except that no GQDs were added during the hydrothermal reaction.

### Example 1.4

### Characterization

SEM was performed using FEI Quanta 400 high-resolution field emission scanning electron microscope in high vacuum mode. TEM was performed using JEOL 2100 field emission gun transmission electron microscope. XPS spectra were taken on a PHI Quantera SXM scanning X-ray microprobe with a monochromatic 1486.7 eV Al Kα X-ray line source, 45° take off angle, and a 200 μm beam size. XPS spectra were taken on a PHI Quantera SXM scanning X-ray microprobe. Al anode at 25 W was used as an X-ray source with a pass energy of 26.00 eV, 45° take off angle, and a 100 μm beam size. A pass energy of 140 eV was used for survey and 26 eV for atomic concentration. Raman spectroscopy (Renishaw inVia) was performed at 514.5 nm laser excitation at a power of 20 mW.

### Example 1.5

### Electrochemical Characterization

CV and RDE studies were conducted in a home-built electrochemical cell using a Ag/AgCl electrode as the reference electrode and a Pt wire as the counter electrode. For preparation of the electrode, BN-GQD/GO catalyst (2 mg) and 2 mL of 0.5 wt % Nafion aqueous solution were mixed and dispersed by sonication until a homogeneous ink was formed. Then, 16 μL of the catalyst ink was loaded onto a glassy carbon electrode (5 mm in diameter). The catalyst ink was dried slowly in air. A flow of O₂ was maintained in the electrolyte during the measurement to ensure continuous O₂ saturation. Commercial 20 wt % platinum on Vulcan carbon black (Pt/C from Alfa Aesa) was used for comparison, with all the testing parameters kept the same as that used for the BN-GQD/GO electrode.

### Example 1.6

### ORR Activity Calculations

The kinetic parameters (n and J_{K}) were analyzed by Koutecky-Levich equations 1 and 2 as follows:

$$\begin{matrix}\frac{1}{j} = \frac{1}{{j}_{K}} + \frac{1}{B {ω}^{1 / 2}} & ( 1 ) \\ B = 0.2 n F {( {D}_{o} )}^{2 / 3} {v}^{- 1 / 6} {C}_{o} & ( 2 )\end{matrix}$$

In the above equations, j and j_{K} represent the measured and kinetic current density, respectively, ω is the electrode rotating rate, n is the electron transfer number, F is the Faraday constant (F=96485 C mol⁻¹), D_{O} is the diffusion coefficient of O₂, v is the kinetic viscosity, and C_{O} is the bulk concentration of O₂. The constant 0.2 is adopted when the rotating speed is expressed in rpm.

For the RRDE measurements, catalyst inks and electrodes were prepared by the same method as those of RDE. The disk electrode was scanned at a rate of 5 mV s⁻¹ and the ring potential was kept constant at 0.5 V vs. Ag/AgCl. The HO₂⁻ and n were calculated by equations 3 and 4:

$$\begin{matrix}{HO}_{2}^{-} \% = 200 \times \frac{{I}_{r} / N}{{I}_{d} + {I}_{r} / N} & ( 3 ) \\ n = 4 \times \frac{{I}_{d}}{{I}_{d} + {I}_{r} / N} & ( 4 )\end{matrix}$$

In the above equations, I_{d} is disk current, Iᵣ is ring current, and N is 0.36. N represents the collection efficiency.

Without further elaboration, it is believed that one skilled in the art can, using the description herein, utilize the present disclosure to its fullest extent. The embodiments described herein are to be construed as illustrative and not as constraining the remainder of the disclosure in any way whatsoever. While the embodiments have been shown and described, many variations and modifications thereof can be made by one skilled in the art without departing from the spirit and teachings of the invention. Accordingly, the scope of protection is not limited by the description set out above, but is only limited by the claims, including all equivalents of the subject matter of the claims. The disclosures of all patents, patent applications and publications cited herein are hereby incorporated herein by reference, to the extent that they provide procedural or other details consistent with and supplementary to those set forth herein.

What is claimed is:

1. A method of making a composite, said method comprising:
associating graphene quantum dots with a carbon material,
wherein the associating results in assembly of the graphene quantum dots on a surface of the carbon material.

2. The method of claim 1, wherein the associating occurs by a method selected from the group consisting of mixing, stirring, sonication, freeze-drying, hydrothermal treatment, annealing, and combinations thereof.

3. The method of claim 1, wherein the associating occurs by hydrothermal treatment.

4. The method of claim 1, wherein the graphene quantum dots are assembled on the surface of the carbon material through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

5. The method of claim 1, wherein the graphene quantum dots are assembled on the surface of the carbon material through self-assembly.

6. The method of claim 1, wherein the graphene quantum dots are selected from the group consisting of unfunctionalized graphene quantum dots, functionalized graphene quantum dots, graphene oxide quantum dots, graphene oxide nanoribbon quantum dots, graphene nanoribbon quantum dots, coal-derived graphene quantum dots, coke-derived graphene quantum dots, biochar-derived graphene quantum dots, and combinations thereof.

7. The method of claim 1, wherein the graphene quantum dots comprise a crystalline hexagonal structure.

8. The method of claim 1, wherein the graphene quantum dots are functionalized with a plurality of functional groups.

9. The method of claim 8, wherein the functional groups are selected from the group consisting of amorphous carbons, oxygen groups, carbonyl groups, carboxyl groups, hydroxyl groups, esters, amines, amides, alkyls, aromatics, and combinations thereof.

10. The method of claim 1, wherein the graphene quantum dots are dispersed on the surface of the carbon material.

11. The method of claim 1, wherein the graphene quantum dots form an interconnected network on the surface of the carbon material.

12. The method of claim 1, wherein the carbon material is selected from the group consisting of graphite, graphite oxide, graphene, graphene oxide, graphene nanoribbons, graphene oxide nanoribbons, carbon nanofibers, carbon nanotubes, split carbon nanotubes, activated carbon, carbon black, functionalized carbon materials, pristine carbon materials, doped carbon materials, reduced carbon materials, stacks thereof, and combinations thereof.

13. The method of claim 1, wherein the carbon material comprises conjugated domains.

14. The method of claim 1, wherein the carbon material is in the form of flakes.

15. The method of claim 1, wherein the carbon material is in the form of a sheet.

16. The method of claim 1, wherein the carbon material comprises a single layer.

17. The method of claim 1, wherein the carbon material comprises a plurality of layers.

18. The method of claim 1, wherein the carbon material comprises from about two layers to about ten layers.

19. The method of claim 1, wherein the carbon materials are functionalized with a plurality of functional groups.

20. The method of claim 19, wherein the functional groups are selected from the group consisting of amorphous carbon, oxygen groups, carbonyl groups, carboxyl groups, hydroxyl groups, esters, amines, amides, alkyls, aromatics, and combinations thereof.

21. The method of claim 1, further comprising a step of doping at least one of the graphene quantum dots and the carbon material with one or more dopants.

22. The method of claim 21, wherein the doping occurs during associating the graphene quantum dots with the carbon material.

23. The method of claim 21, wherein the doping occurs after associating the graphene quantum dots with the carbon material.

24. The method of claim 21, wherein the dopant is selected from the group consisting of boron, nitrogen, oxygen, aluminum, gold, phosphorous, silicon, sulfur, metals, metal oxides, transition metals, transition metal oxides, heteroatoms thereof, and combinations thereof.

25. The method of claim 21, wherein the dopant comprises boron and nitrogen.

26. The method of claim 21, wherein the doping occurs by annealing.

27. The method of claim 1, wherein the composite is in the form of flat sheets.

28. The method of claim 1, wherein the composite has a thickness ranging from about 5 nm to about 1 μm.

29. The method of claim 1, wherein the composite has a thickness ranging from about 5 nm to about 10 nm.

30. The method of claim 1, wherein the composite has a surface area ranging from about 200 m²/g to about 500 m²/g.

31. The method of claim 1, wherein the composite is capable of mediating oxygen reduction reactions, oxygen evolution reactions, hydrogen oxidation reactions, hydrogen evolution reactions, and combinations thereof.

32. The method of claim 1, wherein the composite has a current density that ranges from about 1 mA/cm² to about 15 mA/cm².

33. The method of claim 1, wherein the composite has a current density that ranges from about 2 mA/cm² to about 4 mA/cm².

34. The method of claim 1, wherein the composite is used as an electrocatalyst for oxygen reduction reactions, oxygen evolution reactions, hydrogen oxidation reactions, hydrogen evolution reactions, and combinations thereof.

35. The method of claim 1, wherein the composite is utilized as a component of an energy storage device.

36. A composite comprising:
graphene quantum dots; and
a carbon material,
wherein the graphene quantum dots are assembled on a surface of the carbon material.

37. The composite of claim 36, wherein the graphene quantum dots are assembled on the surface of the carbon material through at least one of covalent bonds, non-covalent bonds, ionic interactions, acid-base interactions, hydrogen bonding interactions, pi-stacking interactions, van der Waals interactions, adsorption, physisorption, self-assembly, stacking, packing, sequestration, and combinations thereof.

38. The composite of claim 36, wherein the graphene quantum dots are selected from the group consisting of unfunctionalized graphene quantum dots, functionalized graphene quantum dots, graphene oxide quantum dots, graphene oxide nanoribbon quantum dots, graphene nanoribbon quantum dots, coal-derived graphene quantum dots, coke-derived graphene quantum dots, biochar-derived graphene quantum dots, and combinations thereof.

39. The composite of claim 36, wherein the graphene quantum dots comprise a crystalline hexagonal structure.

40. The composite of claim 36, wherein the graphene quantum dots are functionalized with a plurality of functional groups.

41. The composite of claim 41, wherein the functional groups are selected from the group consisting of amorphous carbons, oxygen groups, carbonyl groups, carboxyl groups, hydroxyl groups, esters, amines, amides, alkyls, aromatics and combinations thereof.

42. The composite of claim 36, wherein the graphene quantum dots are dispersed on the surface of the carbon material.

43. The composite of claim 36, wherein the graphene quantum dots form an interconnected network on the surface of the carbon material.

44. The composite of claim 36, wherein the carbon material is selected from the group consisting of graphite, graphite oxide, graphene, graphene oxide, graphene nanoribbons, graphene oxide nanoribbons, carbon nanofibers, carbon nanotubes, split carbon nanotubes, activated carbon, carbon black, functionalized carbon materials, pristine carbon materials, doped carbon materials, reduced carbon materials, stacks thereof, and combinations thereof.

45. The composite of claim 36, wherein the carbon material comprises conjugated domains.

46. The composite of claim 36, wherein the carbon material is in the form of a sheet.

47. The composite of claim 36, wherein the carbon material comprises a single layer.

48. The composite of claim 36, wherein the carbon material comprises a plurality of layers.

49. The composite of claim 36, wherein the carbon material comprises from about two layers to about ten layers.

50. The composite of claim 36, wherein the carbon materials are functionalized with a plurality of functional groups.

51. The composite of claim 50, wherein the functional groups are selected from the group consisting of amorphous carbon, oxygen groups, carbonyl groups, carboxyl groups, hydroxyl groups, esters, amines, amides, alkyls, aromatics, and combinations thereof.

52. The composite of claim 36, wherein the composite is doped with one or more dopants.

53. The composite of claim 52, wherein the dopant is selected from the group consisting of boron, nitrogen, oxygen, aluminum, gold, phosphorous, silicon, sulfur, metals, metal oxides, transition metals, transition metal oxides, heteroatoms thereof, and combinations thereof.

54. The composite of claim 52, wherein the dopant comprises boron and nitrogen.

55. The composite of claim 36, wherein the composite is in the form of flat sheets.

56. The composite of claim 36, wherein the composite has a thickness ranging from about 5 nm to about 1 μm.

57. The composite of claim 36, wherein the composite has a thickness ranging from about 5 nm to about 10 nm.

58. The composite of claim 36, wherein the composite has a surface area ranging from about 200 m²/g to about 500 m²/g.

59. The composite of claim 36, wherein the composite is capable of mediating oxygen reduction reactions, oxygen evolution reactions, hydrogen oxidation reactions, hydrogen evolution reactions, and combinations thereof.

60. The composite of claim 36, wherein the composite has a current density that ranges from about 1 mA/cm² to about 15 mA/cm².

61. The composite of claim 36, wherein the composite has a current density that ranges from about 2 mA/cm² to about 4 mA/cm².
